(19) United States
(12) Patent Application Publication
(10) Pub. No.: US 2005/0036158 A1
(43) Pub. Date: Feb. 17, 2005

(54) Method for displaying multiple versions of a digital image

(75) Inventors: Gary L. House, Victor, NY (US); John R. Reinert Nash, Prior Lake, MN (US)

Correspondence Address: Milton S. Sales;Patent Legal Staff, Eastman Kodak Company, 343 State Street, Rochester, NY, 14650-2201, US

(73) Assignee: Eastman Kodak Company

(21) Appl. No.: 10/638,866

(22) Filed: Aug. 11, 2003

(51) Int. Cl. G06K 15/02; H04N 1/387; H04N 1/50

(52) U.S. Cl. 358/1.9; 358/1.17; 358/1.18; 358/450; 358/527

(57) ABSTRACT

The present invention relates to an imaging service method which permits a consumer to view multiple renderings of an image or images supplied by the consumer. The image looks as provided by the slideshow of the present invention permits the consumer to see how an image or aspects of the image change among the various renderings prior to a hard copy output. With the method of the present invention, at least one image received from a customer can be modified to create a plurality of versions of the one image, and a slideshow is created to display each version of the one image for a predetermined period of time. The slideshow can be placed on a digital image storage media so as to permit the consumer to view the slideshow.

### FIELD OF THE INVENTION

The present invention relates to the printing and/or displaying of images, and more particularly, the display of multiple versions or renderings of a digital image, wherein each version has a distinct characteristic or look, and a desired look is chosen for printing.

### BACKGROUND OF THE INVENTION

With the advent of digital technology, various enhancements, modifications and/or corrections may be provided to images which are, for example, scanned from film or electronically received at a photofinishing station. That is, the use of digital technology permits modifications to images in a manner in which different characteristics, looks, or renderings outside of traditional color can be applied to images. However, since a consumer normally does not look at his/her images in various different versions or renderings, it is difficult for a consumer to realize how an image would look in a format different than a traditional color format. This is due to the fact that there is no known mechanism or device which permits a viewer to easily, quickly and automatically preview multiple versions of their submitted image.

That is, images may be rendered to yield a print “look”, wherein a look is defined as a combination of tone color scale, color saturation, preferred/accurate hue, contrast, or sharpness position; or may be rendered in a specific manner so as to provide for a black and white version of the image, a sepia version of the image, a cartoon version of the image, one or more versions of varying color saturation of the image, a gothic or architectural version of the image, or a special effect version of the image. As noted above, it is often difficult to convey to consumers a choice of renderings since they usually are not familiar with the technical terminology that researchers use to describe these looks or they may not know exactly how a specific image may appear with a specific look. It is also difficult to anticipate the individual image look preferences of consumers.

### SUMMARY OF THE INVENTION

The present invention provides for a method of showing multiple renderings of an image in a slideshow. The slideshow in accordance with the present invention may include the sequential showing of an image or images to show each rendering of the image or images; or the showing of a set of renderings of an individual image side-by-side or as a template of images with the possibility of examining each set of image renderings in sequence, (that is, if there is one or more images then each set of renderings can be displayed on an individual image by image basis via the slideshow). With the method of the present invention, multiple renderings or “looks” of an image or a series of images can be shown in a slideshow format. Potential methods of delivery of the slideshow with respect to the method of the present invention includes software on a CD-ROM, DVD-ROM or other digital storage device, as well as delivery via a web page or other network communication method. The sequence of distinct image characteristics or looks permits the consumer or customer to see how his/her image or aspects of the image change among the various renderings prior to a hard copy output.

Accordingly, the present invention provides for an imaging service method which comprises the steps of receiving at least one image from a customer; modifying the one image to create a plurality of versions of the one image, with each version of the one image having a distinct look; formatting the plurality of versions of the one image into a slideshow which is adapted to sequentially display each version of the image for a predetermined period of time; and placing the slideshow including the plurality of versions of the one image onto a digital image storage media, including a networked image server.

The present invention further provides for an imaging service method which comprises the steps of obtaining a digital record of a customer image order containing a plurality of images; selecting at least one image from the plurality of images for modification to create multiple versions of the at least one image, with each version of the at least one image defining a distinct appearance characteristic; formatting the multiple versions of the at least one image into a slideshow which is adapted to display each version of the at least one image for a predetermined period of time; and placing the slideshow including the multiple versions of the at least one image onto a digital storage media.

The present invention further relates to an imaging service method which comprises the steps of obtaining a digital record of a customer image order containing a plurality of original images; modifying each of the original images in the customer image order by applying an appearance characteristic to each of the original images to create a parallel set of images which are different from the original images; formatting the parallel set of images into a slideshow which is adapted to sequentially display each image for a period of time; and placing the slideshow onto a digital storage media.

The present invention further relates to a digital image storage media that comprises a slideshow having a plurality of versions of an image thereon, with each version of the image having a distinct look. The digital image storage media of the present invention is adapted to be inserted into a display device and sequentially display each version of the image for a predetermined period of time on the display device.

The present invention further relates to a digital image storage media that comprises a slideshow having a plurality of sets of images thereon, with each of the sets of images defining a distinct look and being formatted into a slideshow. The digital image storage media of the present invention is adapted to be inserted into a display device and sequentially display each of the set of images for a predetermined period of time to display the distinct look associated with each of the sets of images.

The present invention further relates to a method of making a digital image storage media which comprises the steps of modifying an image to create a plurality of versions of the image, with the modifying step comprising applying a distinct look to each version of the image; formatting the plurality of versions of the image into a slideshow which is adapted to display each version of the image for a predetermined period of time; and placing the slideshow including the plurality of versions of the image onto the digital image storage media.

### BRIEF DESCRIPTION OF THE DRAWINGS

FIG. 1 schematically illustrates a processing or photofinishing system which can be utilized with the method and system of the present invention;

FIG. 2 schematically shows a system in accordance with the present invention;

FIG. 3 is a flow-chart detailing a process with respect to method of the present invention;

FIGS. 4A and 4B schematically illustrate a display at different times to represent different versions of an image being shown on the display; and

FIGS. 5A and 5B illustrate a different embodiment of the display of FIGS. 4A and 4B.

### DETAILED DESCRIPTION OF THE INVENTION

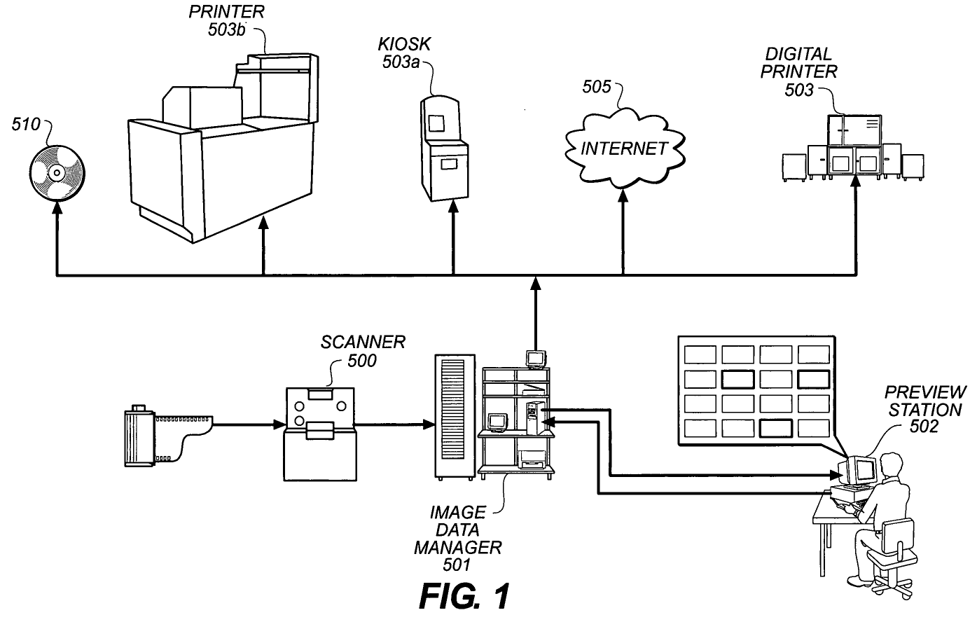

Referring now to the drawings, wherein like reference numerals represent identical or corresponding parts throughout these several views, FIG. 1 schematically illustrates a photofinishing lab for receiving and processing photographic images. As shown in FIG. 1, a customer or consumer order including film is scanned at a scanner 500 to create a digital record of the customer images. From there, the digital record of the images is processed at an image data manager (IDM) 501, and optionally, an operator can preview images at a preview station 502. A digital printer 503 can be operationally associated with IDM 501 to produce service prints, index prints, etc. based on a customer order. As a further option, the images can be forwarded to a customer's home computer or some further location via an internet connection 505. As a still further option, the images can be forwarded to a kiosk 503a operationally associated with IDM 501 via a kiosk commission or to a remote printer 503b. As a still further option, the images can be placed on a digital storage media such as a CD ROM or a DVD for delivery to a customer.

As described above, digital technology permits the enhancement and/or modification of images to the point that images can be rendered to yield distinct characteristics or looks. Traditionally, the majority of orders from a consumer request the creation of standard traditional color prints. Consumers are normally not familiar with the choice of renderings or how multiple versions of their images would look since it is difficult to convey the multiple looks to the consumer in an efficient and simple manner while using the customary method of an envelope to deliver photographic prints to a consumer. The present invention takes advantage of the creation of CDs or DVDs which are adapted to sequentially show multiple renderings or looks of an image or a series of images in a slideshow format. By providing for a slideshow of the customer's images, wherein each image has a distinct look, it is possible for the customer to receive the CD or DVD with the envelope that may include his photographs. The customer can then view the multiple renderings of his image and possibly select an image or images having a desired look for printing.

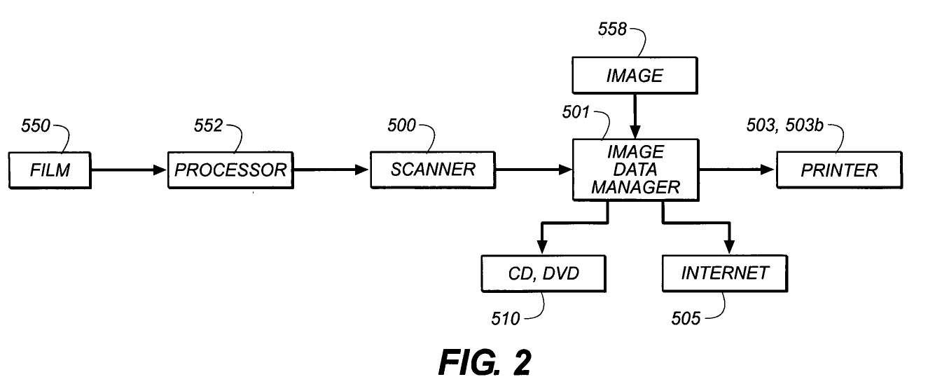

A system in accordance with the present invention is schematically shown with respect to FIG. 2. In one aspect of the present invention, when the image is captured on film 550 it is processed in a processor 552, and thereafter, the processed film is scanned by a scanner 500. At that point, a digital record of the image captured on the film is created. This digital record is sent to image data manager 501 where the image can be manipulated in multiple ways. For example, the image can be corrected, enhanced, modified, etc. The present invention enables the creation of multiple renderings of the image so as to permit a customer to see his/her image in the format of these multiple renderings. Therefore, in one aspect of the present invention, image data manager 501 would include software which is adapted to modify at least one of the customer's images to create a plurality of versions of the image, with each version of the image having a distinct look. Thereafter, the plurality of versions of the images are formatted into a slideshow which is adapted to sequentially display each version (or sets of renderings of each individual image) of the one image for a predetermined period of time and the slideshow is provided on a CD or DVD 510. This CD or DVD can thereafter be given to the customer along with his/her prints provided by printer 503, 503b or optionally kiosk 503a equipped with a CD burner and/or a printer. With the CD/DVD, the customer simply has to load the CD/DVD into his/her computer or player to display the plurality of versions of the modified image in a sequential manner by way of the slideshow. Easy customer navigation of the slideshow on the CD/DVD would also be enabled. This permits the customer to view his/her image in different appearance look formats and gives the customer an opportunity to order a specific look which may be appealing with respect to the modified images. As a further option, the slideshow can be sent to the customer via the internet 505 for the purposes of the customer viewing the slideshow on his/her own computer.

Of course, the present invention is not limited to images from scanned films and electronic images 558 can be provided directly to image data manager 501 from, for example, the internet or some kind of digital storage media.

With respect to the distinct looks for the multiple versions of the modified image, the looks could be in the form of a black and white version of the image, a sepia version of the image, a cartoon version of the image, one or more saturated color versions of the image, a gothic (highly lined architectural like appearance) version of the image, a special effect version of the image, etc. The special effect version of the image can essentially be a posterized, cartoonized or artistic version of the image which accentuates edges, reduces fine detail and in some instances accentuates color saturation for special effect. Each version can be sequentially shown for a time period in the slideshow so as to provide the customer with the opportunity to see his image in each of the noted different versions.

In a feature of the present invention, one of the images from the customer order can be selected by the service provider or the customer so as to be rendered to create multiple versions of the image, or each image can be modified in the manner described above so as to create multiple versions of the images. With regard to a service provider selecting at least one of the customer images, algorithms can be utilized by the service provider to review the image content of the customer's image. For example, it is known that images which include human faces are generally important to customers. Therefore, specific algorithms which detect faces can be utilized to select at least one of the customer's images which includes at least one face so as to render this one image multiple times by applying different looks to this one image. The selected image would then be rendered in the form of, for example, a black and white image, a cartoon image, a sepia image, a saturated color image, a gothic image, a special effect image, etc., and each version of the image placed in a slideshow on a CD or DVD, so as to permit a consumer to view the slideshow in a sequential manner and thus, see how the image appears with the different looks.

As a further option, a different look can be applied to all of the images in the customer order, and thereafter, a slideshow with these images would be placed on the CD or DVD and presented to the customer. With this alternative approach, the customer can view how each of his/her images would look with different looks or characteristics applied thereto.

In a further feature for the selecting step, it may be known that certain images such as landscape images may look best when combined with certain characteristics or looks, and thus, that scene would be selected for the sequential image viewing CD or DVD.

As a still further option, the selecting step could include comparing the image content of the customer's images to a stored catalog of appearance characteristics which the photofinisher or service provider has, and selecting an image having an image content which would be most compatible with the stored catalog of appearance characteristics. That is, images would be compared to the stored catalog of appearance characteristics and those appearance characteristics which would most benefit the selected image would be applied to the image so as to create multiple renderings of the image.

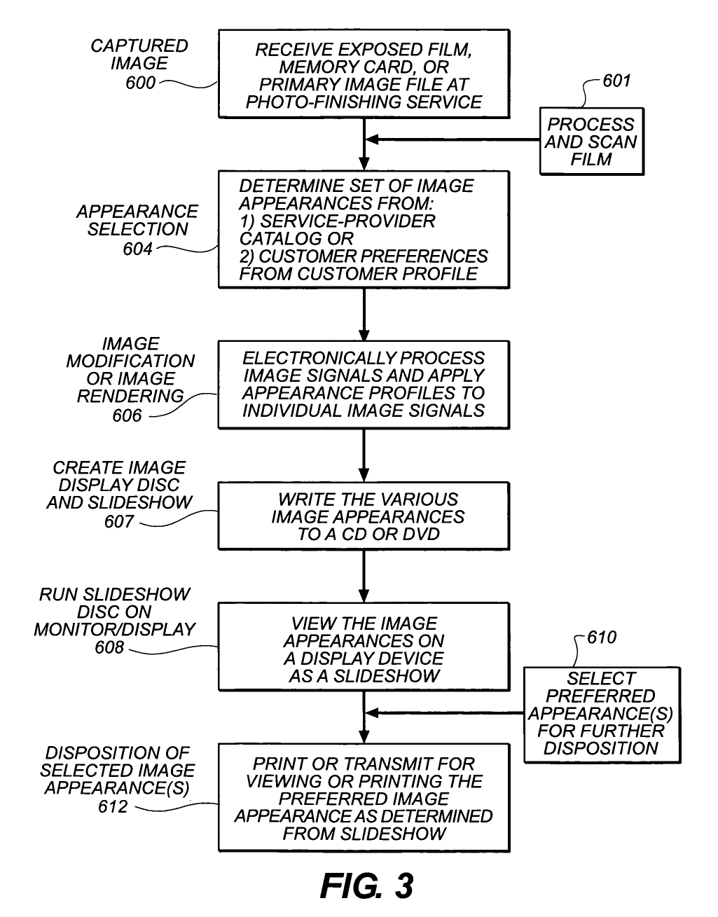

FIG. 3 illustrates further details of the concept of capturing and selecting an image for a CD or DVD slideshow in accordance with the present invention. As noted in FIG. 3, in step 600 (image capture) an image can be received from an exposed film, memory card or a primary image file at a photofinishing service. As a further option (step 601), the image can be received from processed and scanned film. Step 604 is an appearance selection step. That is, in one option for practicing the present invention, the service provider can determine the set of image characteristics or looks which are to be applied to the image or images based on a catalog or look-up table of the service provider or based on a pre-existing customer preference from a customer profile. Once the appearance selection characteristics or looks are chosen and the image or images are selected, the image or images is/are appropriately modified to create multiple versions of the image or images based on each of the chosen characteristics or looks. In step 606 (image modification or renderings), the image signals are electronically processed to apply the chosen characteristics or appearance profiles to the individual image signals. Thereafter, in step 607 an image display disc and slideshow are created. That is, the various renderings of the selected image are written onto a CD or DVD. The CD or DVD can thereafter be provided to the consumer who can view the multiple image appearances or rendering on the display device as a slideshow (step 608).

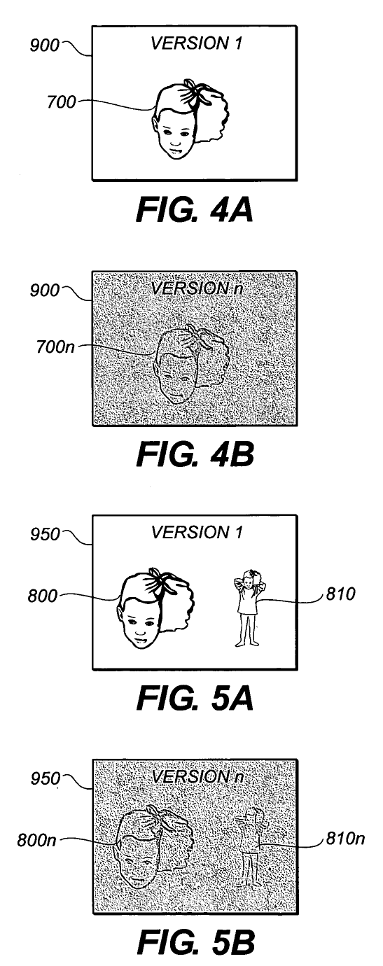

FIGS. 4A-4B and 5A-5B schematically illustrate the display of the customer's image or images when a customer inserts a CD or DVD with a slideshow in accordance with the present invention into his/her computer. FIG. 4A shows a display 900 at time 1, wherein version 1 of the slideshow for image 700 (for example, black and white) is shown. FIG. 4B illustrates the same display 900 a short or predetermined time later or at a time 1+x, wherein version n or 2 of the slideshow for image 700 is shown as image 700n. The second version (image 700n) could be a cartoon image, sepia image, etc. The slideshow continues scrolling through each version of image 700 that is on the CD to permit the customer to appreciate how his/her image looks for each version.

FIGS. 5A-5B illustrate a display 950 where a variation of the slideshow of FIGS. 4A-4B is shown. In FIG. 5A, version 1 of the slideshow for images 800 and 810 is shown side by side or as a template at time 1. FIG. 5B shows display 950 a short or predetermined time later in which the slideshow is scrolled to version n or 2 at time 1+x, wherein images 800 and 810 in accordance with the present invention are now seen as images 800n and 810n and have a different characteristic or look from version 1. In FIGS. 5A-5B the customer can see two or more images (depending on the size of the image) scrolling on the display in a slideshow format, and can further see how the images appear in the noted different versions.

Therefore, the method and system of the present invention provides the consumer with an idea on how at least one of his/her images looks in a different rendered format, and the consumer can be given the option of selecting a preferred appearance for further disposition (step 610). Based on the consumer selection, the selected image can thereafter be transmitted for viewing or printed based on the appearance in the slideshow (step 612).

Further, the present invention permits a consumer to view a sequential showing of multiple renderings of a series of images in a slideshow format. The slideshow is provided to the consumer in the form of a CD ROM or DVD ROM or some other type of mass storage device and further, can be delivered to the customer via a web page or other network communication method. The sequence of image looks allows the consumer to see how the image or aspects of the image change among the various renderings prior to hardcopy output.

In the present invention, distinct characteristics or looks are applied during the rendering of the image. Image sources as described include scanned optical films, scan-only films, digital still cameras, scanned reflection prints, and other sources of digital image files. The looks may be applied to various color spaces including sRGB, ERIMM, and RPD.

Upon selecting preferred renditions from the slideshow, end users could use these fully rendered image digital files to make prints on a home printer, deliver to a photofinisher for hardcopy prints, up-load to an on-line fulfillment service to obtain prints, or send via electronic means, for example, e-mail to others. This system can provide the user with several looks for an entire order or on an individual frame-by-frame basis or image basis. Alternatively, a software selection of predicted (or pre-selected) preferred looks could be used. For example, image/object recognition software could detect the existence of faces and select looks known to be preferred to such images, while selecting other looks for landscaped photography. Other possible modes of selection include the amount of noise detected in the image (by noise estimation algorithms), image contrast, and amounts of saturated colors in the image. Methods of ordering the preferred looks includes a preview station (run by the customer or the photofinisher), a checkbox on a processing envelope delivered to the photofinisher, and a selection on a web page or other online medium, and by return of the CD/DVD—if write or edit enabled.

The invention has been described in detail with particular reference to certain preferred embodiments thereof, but it will be understood that variations and modifications can be effected within the spirit and scope of the invention.

1. A imaging service method comprising the steps of:
receiving at least one image from a customer;
modifying said one image to create a plurality of versions of said one image, each version of said one image having a distinct look;
formatting said plurality of versions of said one image into a slideshow which is adapted to sequentially display each version of said one image for a predetermined period of time; and
placing said slideshow including said plurality of versions of said one image onto a digital image storage media.

2. A method according to claim 1, wherein said digital image storage media is a disk

3. A method according to claim 1, wherein said modifying step comprises rendering said one image to create at least a black and white version of said one image, a sepia version of said one image, a cartoon version of said one image, one or more version of color saturation of said one image, a gothic version of said one image or a special effect version of said one image.

4. A method according to claim 1, wherein said formatting step comprises formatting sets of images into said slideshow such that different versions of said sets of images sequentially appear in a side by side manner on a display.

5. An imaging service method comprising the steps of:
obtaining a digital record of a customer image order containing a plurality of images;
selecting at least one image from said plurality of images for modification to create multiple versions of said at least one image, each version of said at least one image defines a distinct appearance characteristic;
formatting said multiple versions of said at least one image into a slideshow which is adapted to display each version of said at least one image for a predetermined period of time; and
placing said slideshow including said multiple versions of said at least one image onto a digital storage media.

6. A method according to claim 5, wherein said digital storage media is a disk and said slideshow is adapted to sequentially display each version of said at least one image.

7. A method according to claim 5, wherein said distinct appearance characteristic for said at least one image comprises a black and white version of said at least one image, a sepia version of said at least one image, a cartoon version of said at least one image, a saturated color version of said at least one image, a gothic version of said at least one image or a special effect version of said at least one image.

8. A method according to claim 5, wherein said selecting step comprises selecting an image from said plurality of images which includes at least one face.

9. A method according to claim 5, wherein said selecting step comprises selecting an image from said plurality of images which includes a landscape scene.

10. A method according to claim 5, wherein said selecting step comprises comparing said images to a stored catalog of appearance characteristics and selecting an image having an image content which is compatible with said appearance characteristics.

11. An imaging service method comprising the steps of:
obtaining a digital record of a customer image order containing a plurality of original images;
modifying each of the original images in the customer image order by applying an appearance characteristic to each of said original images to create a parallel set of images which differ from the original images;
formatting said parallel set of images into a slideshow which is adapted to sequentially display each image for a predetermined period of time; and
placing said slideshow onto a digital storage media.

12. A method according to claim 11, wherein said digital storage media is a disk.

13. A digital image storage media comprising:
a slideshow having a plurality of versions of an image thereon, each version of said image having a distinct look, wherein said digital image storage media is adapted to be inserted into a display device and sequentially display each version of said image for a predetermined period of time on said display device.

14. A digital image storage media according to claim 13, wherein said digital image storage media is a disk.

15. A digital image storage media according to claim 13, wherein said distinct look is at least a black and white version of said image, a sepia version of said image, a cartoon version of said image, one or more versions of color saturation of said image, a gothic version of said image or a special effect version of said image.

16. A digital image storage media comprising:
a slideshow having a plurality of sets of images thereon, each of said sets of images defining a distinct look and being formatted into a slideshow, wherein said digital image storage media is adapted to be inserted into a display device and sequentially display each of said set of images for a predetermined period of time to display the distinct look associated with each of said sets of images.

17. A digital image storage media according to claim 16, wherein said digital image storage media is a disk.

18. A digital image storage media according to claim 16, wherein said distinct look is at least a black and white version of said set of images, a sepia version of said set of images, a cartoon version of said set of image, one or more versions of color saturation of said set of images, a gothic version of said set of images or a special effect version of said images.

19. A method of making a digital image storage media, the method comprising the steps of:
modifying an image to create a plurality of versions of said image, said modifying step comprising applying a distinct look to each version of said image;
formatting said plurality of versions of said image into a slideshow which is adapted to display each version of said image for a predetermined period of time; and
placing said slideshow including said plurality of versions of said image onto said digital image storage media.

20. A method according to claim 19, wherein said digital image storage media is a disk.

21. A method according to claim 19, wherein said distinct look is at least a black and white version of said image, a sepia version of said image, a cartoon version of said image, one or more versions of color saturation of said image, a gothic version of said image or a special effect version of said image.
